(19) United States
(12) Patent Application Publication
(10) Pub. No.: US 2015/0048708 A1
(43) Pub. Date: Feb. 19, 2015

(54) STATOR AND ROTOR FOR AN ELECTRIC MACHINE

(71) Applicant: HÖGANÄS B (PUBL), Höganäs (SE)

(72) Inventors: Göran Nord, Helsingborg (SE); Jamie Washington, Sowerby Bridge (GB)

(21) Appl. No.: 14/384,555

(22) PCT Filed: Mar. 8, 2013
(86) PCT No.: PCT/EP2013/054690

§ 371 Date: Sep. 11, 2014

(30) Foreign Application Priority Data
Mar. 12, 2012 (EP) 12158988.1

(51) Int. Cl. H02K 1/14; H02K 15/02; H02K 1/27

(52) U.S. Cl. CPC H02K 1/145; H02K 1/141; H02K 1/27; H02K 15/022
USPC 310/156.56; 310/257; 310/156.66; 29/596

(57) ABSTRACT

A stator for an electric machine, the stator including a stator core and a winding. The stator core including an annular stator core back component providing a magnetic flux path in a circumferential direction and in an axial direction of the annular stator core back component; and a plurality of stator pole components each including a mounting part mounted to the stator core back component, an interface part defining an interface surface facing an active air gap between the stator and a rotor of the electrical machine; and a radially oriented tooth part extending radially from the annular stator core component and connecting the interface part with the mounting part.

### FIELD OF THE INVENTION

This invention generally relates to electric machines and, in particular, to modulated pole machines. More particularly, the invention relates to a stator and to a rotor for such an electric machine.

### BACKGROUND OF THE INVENTION

Over the years, electric machine designs such as modulated pole machines, e.g. claw pole machines, Lundell machines and transverse flux machines (TFM) have attracted increased interest. Electric machines using the principles of these machines were disclosed as early as 1890 in U.S. Pat. No. 437,501 and about 1910 by Alexandersson and Fessenden. One of the reasons for the increasing interest is that the design enables a very high torque output in relation to, for instance, induction machines, switched reluctance machines and even permanent magnet brushless machines. Further, such machines are advantageous in that the coil is often easy to manufacture. However, one of the drawbacks of the design is that they are often relatively expensive to manufacture.

A stator of a modulated pole electric machine generally comprises a central single winding that magnetically feeds multiple teeth formed by a soft magnetic stator core structure. The soft magnetic core is formed around the winding, while for other common electrical machine structures the winding is formed around a tooth of the core section. Examples of the modulated pole machine topology are sometimes recognised as e.g. Claw-pole-, Crow-feet-, Lundell- or TFM-machines. The modulated pole machine with buried magnets is further characterised by an active rotor structure including a plurality of permanent magnets being separated by rotor pole sections.

The transverse flux machine (TFM) topology is an example of a modulated pole machine. It is known to have a number of advantages over conventional machines. The basic design of a single-sided radial flux stator is characterized by a single, simple phase winding parallel to the air gap and with a more or less U-shaped yoke section surrounding the winding and exposing in principal two parallel rows of teeth's facing the air gap. Multi-phase arrangements include magnetically separated single phase units stacked perpendicular to the direction of motion of the rotor or mover. The phases are then electrically and magnetically shifted by 120 degrees for a three-phase arrangement to smooth the operation and produce a more or less even force or torque independent of the position of the rotor or mover. Note here that the angle referred to is given in electrical degrees which is equivalent to mechanical degrees divided by the number of pairs of magnetic poles.

In so-called claw pole machines, the pole teeth of the stator core each comprises a radially-oriented part and an axially-oriented part that axially extends across the axial extent of the air gap between the stator and the rotor. Currently claw pole machines are restricted to a small size and/or low speed if the stator is constructed completely from steel as typical machines used as car alternators are.

WO2007/024184 discloses an electrical, rotary machine, which includes a first stator core section being substantially circular and including a plurality of teeth, a second stator core section being substantially circular and including a plurality of teeth, a coil arranged between the first and second circular stator core sections, and a rotor including a plurality of permanent magnets. The first stator core section, the second stator core section, the coil and the rotor are encircling a common geometric axis, and the plurality of teeth of the first stator core section and the second stator core section are arranged to protrude towards the rotor. Additionally the teeth of the second stator core section are circumferentially displaced in relation to the teeth of the first stator core section, and the permanent magnets in the rotor are separated in the circumferential direction from each other by axially extending pole sections made from soft magnetic material.

It is generally desirable to provide a stator that results in a robust design of the electric machine. It is generally desirable to provide a stator for a modulated pole machine that allows for a relatively inexpensive production and assembly of the resulting overall electric machine. It is further desirable to provide such a stator that has good performance parameters, such as one or more of the following: high structural stability, low magnetic reluctance, efficient flux path guidance, low weight, small size, high volume specific performance, etc.

Similarly, it is generally desirable to provide a rotor for an electric machine that is robust, relatively inexpensive to manufacture, and has good performance parameters.

### SUMMARY

According to a first aspect, disclosed herein is a stator for an electric machine. The stator comprises a stator core and a winding. Embodiments of the stator core comprise:
an annular stator core back component providing a magnetic flux path in at least a circumferential direction and in an axial direction of the annular stator core back component; and
a plurality of stator pole components each comprising a mounting part mounted to the stator core back component, an interface part defining an interface surface facing an active air gap between the stator and a rotor of the electrical machine; and a radially oriented tooth part extending radially from the annular stator core component and connecting the interface part with the mounting part.

Embodiments of the stator disclosed herein allow for a robust construction of an electric machine such as a Claw Pole type machine.

Hence, embodiments of the stator described herein comprise a plurality of separate components, including an annular stator core back component and a plurality of stator pole components. The individual components of the stator cores are individually manufacturable as separate components. In use, the interface part of each stator pole component may form a magnetic pole of the stator, i.e. the different stator poles are formed by separate respective stator pole components. The stator pole components each comprise a mounting part that allows the stator pole component to be assembled with the annular stator core back component so as to form the assembled stator core.

The individual components of the stator core may be shaped and sized so as to allow the stator core to be manufactured without significantly increasing the manufacturing cost or complexity of the resulting machine. Furthermore, a modification of the rotor compared to other known machines is not required. Nevertheless, embodiments of the stator disclosed herein allow for a very simple rotor construction, while allowing for a reasonably easy assembly of the stator components that normally have a larger size than corresponding rotor. Consequently, embodiments of the stator disclosed herein provide an easier assembly and a reduced cost for the construction of the entire machine.

The modular design of embodiments of the stator disclosed herein allows laminated steel to be used for the stator pole components so as to provide a path for the magnetic flux linking the coil of the machine whilst also keeping the losses in the machine low. When the stator pole components are made of laminated metal sheets, mechanically strong laminations in the air gap region are provided. When the laminated metal sheets are stacked in the circumferential direction, i.e. such that the sheets define a generally axial-radial plane, an efficient axial-radial magnetic flux path is provided in the stator pole components while providing a considerably lower permeability in the circumferential direction than in the axial and radial directions. The use of laminated sheets thus further reduces magnetic leakage between neighbouring stator pole components and Eddy current losses in the circumferential direction. Furthermore, metal sheets laminated in the circumferential direction further provide a high stability against bending due to radial forces.

In some embodiments the metal sheets of the lamination all have the same lamination profile in the direction of stamping, thus reducing the cost of construction. In some embodiments, the individual laminated stator pole components comprise mechanical interlocking features for improved assembly.

In some embodiments, the stator comprises a simple hoop wound coil enclosed by generally L-shaped laminated stator pole components. The magnetic circuit of the stator is completed by an annular stator core back component which can be made of soft magnetic composites (SMC), strip wound laminations, or solid steel.

The stator pole components are arranged to protrude towards the rotor. They are alternatingly arranged on opposite axial sides of the annular stator core back component where the stator pole components arranged on a first side of the annular stator core back component are circumferentially displaced in relation to the stator pole components arranged on a second side of the annular stator core back component, opposite the first side. The annular stator core back component provides a magnetic flux path connecting stator pole components arranged on respective sides of the annular stator core back component.

It is a further advantage of embodiments of the stator described herein that the stator pole components and the annular stator core back component may be mounted to each other in a close fit, i.e. leaving no significant gap between them, as the interface surface between them may be plane, and since they may be pressed together during assembly. Such a close fit which is relatively insensitive to manufacturing tolerances provides an efficient magnetic coupling between the stator pole components and the annular stator core back component.

In some embodiments, the stator is of the claw pole type wherein the interface part of each stator pole component comprises an axially extending claw part. Hence, the stator pole components may be generally L-shaped where a first leg of the L forms the tooth part while the second leg of the L forms the interface part of the stator pole component.

As the axially extending claw parts define an interface surface that axially partially or completely extends across the axial extent of the active air gap region, no or at least less axial flux concentration is required in the rotor, thus reducing the complexity of the rotor construction. Furthermore, embodiments of the stator disclosed herein result in a high torque-density electrical machine and provide an increased performance for a given volume. Embodiments of the stator disclosed herein further allow replacing more expensive materials with cheaper alternatives to further reduce cost.

In some embodiments, the stator pole components attached to the annular stator core back component are claws made of circumferentially stacked laminations that cover the whole axial length of the air gap gathering flux from the permanent magnet rotor.

In some embodiments, the mounting part of each stator pole component comprises an axially extending protrusion or flange. The protrusion may abut a radially-oriented rear surface of the annular stator core back, wherein the rear surface faces away from the interface parts of the stator pole elements. The axially extending protrusion prevents the stator pole component to be radially displaced towards the rotor. Furthermore, the axially extending flange causes an increased flux interface between the stator pole component and the annular stator core back component.

Embodiments of the annular stator core back component described herein are well-suited for production by Powder Metallurgy (P/M) production methods. Accordingly, in some embodiments, the annular stator core back component and/or other components of the electric machine are made from a soft magnetic material such as compacted soft magnetic powder, thereby simplifying the manufacturing of the component in question and providing an effective three-dimensional flux path in the soft magnetic material allowing e.g. radial, axial and circumferential flux path components in a rotary machine. Here and in the following, the term soft magnetic is intended to refer to a material property of a material that can be magnetized but does not tend to stay magnetized, when the magnetising field is removed. Generally a material may be described as soft magnetic when its coercivity is no larger than 1 kA/m (see e.g. “Introduction to Magnetism and Magnetic materials”, David Jiles, First Edition 1991 ISBN 0 412 38630 5 (HB), page 74).

The term “soft magnetic composites” (SMC) as used herein is intended to refer to pressed and heat-treated metal powder components with three-dimensional (3D) magnetic properties. SMC materials are typically composed of surface-insulated iron powder particles that are compacted to form uniform isotropic components that may have complex shapes in a single step.

It is a further advantage of embodiments of the stator described herein that the stator parts made of compacted SMC components have an aspect ratio that allow relatively low-complex tools and an efficient pressing process, employing relatively few compacting steps, while at the same time avoiding unnecessarily complex and fragile components. For example, in some embodiments, the stator pole components are made of laminated metal while the annular stator core back component is a compacted SMC component.

The soft magnetic powder may e.g. be a soft magnetic Iron powder or powder containing Co or Ni or alloys containing parts of the same. The soft magnetic powder may be a substantially pure water atomised iron powder or a sponge iron powder having irregular shaped particles which have been coated with an electrical insulation. In this context the term “substantially pure” means that the powder should be substantially free from inclusions and that the amount of the impurities O, C and N should be kept at a minimum. The average particle sizes are generally below 300 μm and above 10 μm.

However, any soft magnetic metal powder or metal alloy powder may be used as long as the soft magnetic properties are sufficient and that the powder is suitable for die compaction.

The electrical insulation of the powder particles may be made of an inorganic material. Especially suitable are the type of insulation disclosed in U.S. Pat. No. 6,348,265 (which is hereby incorporated by reference), which concerns particles of a base powder consisting of essentially pure iron having an insulating oxygen- and phosphorus-containing barrier. Powders having insulated particles are available as Somaloy® 500, Somaloy® 550 or Somaloy® 700 available from Höganas AB, Sweden.

Embodiments of the annular stator core back component magnetically connect the stator pole components with each other. The annular stator core back component may be made of a simple ring of compacted soft magnetic powder, from strip wound lamination, or solid steel so as to provide a magnetic flux path in the axial and the circumferential direction.

In some embodiments the annular stator core back component comprises indexing means that guide the laminated pieces and assist their proper positioning during assembly of the stator, thus resulting a an assembly process that is easy to automate. For example, when the annular stator core back component is made of compacted SMC, the component can be pressed as a ring including suitable indexing features. The stator pole components and the indexing means may thus have mutually complementing shapes and form a mating connection.

Each indexing means may define an axially-outward oriented mounting surface abutting a corresponding contact surface of one of the stator pole elements; and an indexing element preventing displacement of the stator pole element in a circumferential direction. In this context, the term “axially-outward oriented” is intended to comprise a mounting surface that is oriented exactly in the axial direction but also a mounting surface that defines a direction slightly deviating from the axial direction, e.g. deviating by an angle less than 20°, such as less than 10°. When the mounting surface defines an angle with the axial direction, e.g. less than 20°, such as less than 10°, and when the stator pole components comprise an axially extending claw part, the claw part is likewise oriented at an angle relative to the axial direction. Hence, the term “axially extending claw part” is intended to comprise a claw part that is oriented exactly in the axial direction but also a claw part oriented in a direction slightly deviating from the axial direction, e.g. deviating by an angle less than 20°, such as less than 10°. Such a skewed arrangement of the stator pole elements reduces the so-called cogging torque. Cogging torque refers to the undesirable torque due to the interaction between permanent magnets of the rotor and the stator. It is also known as detent or ‘no-current’ torque.

The stator further comprises a coil that is arranged between the claws and encircles the axis of the machine. The coil may be a simple wound hoop coil that links the flux from the rotor and to which current is applied to produce a torque.

In some embodiments the stator further comprises two end plates, wherein the annular stator core back component and the stator pole components are axially sandwiched between the end plates. The end plates thus allow an efficient and robust assembly of the stator components. At least one of the end plates may comprise indexing features mating with respective ones of the stator pole components.

The present invention relates to different aspects including the stator described above and in the following, a rotor, and corresponding methods, devices, and/or product means, each yielding one or more of the benefits and advantages described in connection with the first mentioned aspect, and each having one or more embodiments corresponding to the embodiments described in connection with the first mentioned aspect and/or disclosed in the appended claims.

According to one aspect, disclosed herein is an electric machine comprising an embodiment of the stator disclosed herein and a rotor magnetically communicating with the stator via an active air gap allowing magnetic flux to communicate between the rotor and the stator. The active air gap is normally filled with air but may be filled with another medium as well.

The electric machine may be a modulated pole machine. In conventional machines, the coils explicitly form the multi-pole structure of the magnetic field, and the magnetic core function is just to carry this multi-pole field to link the magnet and/or other coils. In a modulated pole machine, it is the magnetic circuit which forms the multi-pole magnetic field from a much lower pole (usually two-pole) field produced by the coil. In a modulated pole machine, the magnets usually form the matching multi-pole field explicitly, but it is possible to have the magnetic circuit forming multi-pole fields from a single magnet. The modulated pole machine has a three-dimensional (3D) flux path utilizing magnetic flux paths in the transverse direction (relative to the direction of movement of the rotor) both in the stator and in the moving device, e.g. in the axial direction in a rotating machine, where the moving device is a rotor. Thus in some embodiments the stator device and/or the rotor comprise a three-dimensional (3D) flux path including a flux path component in the axial direction. In some embodiments, the electric machine is of the claw pole type.

In some embodiments of the electric machine, the rotor comprises a plurality of permanent magnets, arranged so that every second magnet along the direction of motion is reversed in magnetisation direction. Generally, the permanent magnets may also be rectilinear rods elongated in the axial direction of the machine; the rods may extend across the axial extent of the active air gap.

In some embodiments the permanent magnets may be magnetised in radial direction. For example, embodiments of the rotor may comprise a plurality of surface mounted permanent magnets. The rotor may comprise a core back, e.g. made of mild steel, thus resulting in a simple construction that allows easy assembly. The rotor may be further simplified by using a Hallbach magnetisation arrangement of the permanent magnets, thus allowing the rotor core back to be omitted.

In alternative embodiments, the rotor comprises a plurality of permanent magnets separated from each other in the direction of motion by pole sections. The plurality of permanent magnets may be magnetised in the circumferential direction. Thereby individual pole sections may only interface with permanent magnet poles showing equal polarity.

According to yet another aspect, disclosed herein is a rotor for an electric machine, the rotor being configured to generate a rotor magnetic field for interaction with a stator magnetic field of a stator, wherein said rotor is adapted to rotate around a longitudinal axis of the rotor, and wherein the rotor comprises:

an annular permanent magnet magnetised in the axial direction,
a plurality of rotor pole components each comprising a mounting part , an interface part defining an interface surface facing an active air gap between the stator and the rotor; and a radially oriented tooth part extending radially relative to the permanent magnet and connecting the interface part with the mounting part.

In some embodiments, the rotor comprises first and second annular rotor core back components; wherein the annular permanent magnet is sandwiched between the first and second annular rotor core back components; and wherein the mounting part of each rotor pole component is coupled to a respective one of the first and second annular rotor core back components. The first and second annular rotor core back components function as flux guiding members and as mounting elements for the rotor pole components. In particular, the annular rotor core back components provide a magnetic flux path connecting respective rotor pole components of first and second subsets of the rotor pole components with the permanent magnet.

In some embodiments, the first annular rotor core back component defines a first axially-outward oriented side face, and the second annular rotor core back component defines a second axially-outward oriented side face opposite the first axially-outward oriented side face; and wherein a first subset of the plurality of rotor pole components are mounted to the first axially-outward oriented side face, and a second subset of the plurality of rotor pole components are mounted to the second axially-outward oriented side face.

In some embodiments, the rotor pole components are distributed along the circumference of the annular rotor core back components, and wherein the rotor pole components of the first and second subsets are arranged in an alternating sequence along the circumference.

Each of the first and second annular rotor core back components may comprise a plurality of indexing means configured to engage with the mounting part of respective ones of the rotor pole components. Each indexing means may define a mounting surface abutting a corresponding contact surface of one of the rotor pole elements; and an indexing element preventing displacement of the rotor pole element in a circumferential direction. The mounting surface may face a direction parallel with the axial direction or a direction that deviates from the axial direction.

Each rotor pole component may comprise laminated metal sheets stacked in the circumferential direction. The interface part of each rotor pole component may comprise an axially extending claw part. The annular rotor core back components may be made of SMC material.

The mounting part of each rotor pole component may comprise an axially extending protrusion, e.g. abutting a radially-oriented rear surface of one of the first and second annular rotor core back components, wherein the rear surface faces away from the interface part of the rotor pole component.

Alternatively, the axially extending protrusion may engage a corresponding recess in an axial side face of one of the rotor core back components.

In some embodiments, the rotor comprises end plates, wherein the annular rotor core back components, annular permanent magnet and the rotor pole components are axially sandwiched between the end plates.

### BRIEF DESCRIPTION OF THE DRAWINGS

The above and/or additional objects, features and advantages of the present invention, will be further elucidated by the following illustrative and non-limiting detailed description of embodiments of the present invention, with reference to the appended drawings, wherein:

FIGS. 1a-b show an example of a modulated pole machine.

FIGS. 2a-c shows an example of a stator for a modulated pole machine.

FIGS. 3a-b show an example of a single-phase stator.

FIGS. 4a-b show an example of a 3-phase outer-rotor electric machine.

FIG. 5 shows an example of a single-phase stator for an outer-rotor electric machine.

FIGS. 6a-b show a more detailed view of a part of the stator of FIG. 5.

FIG. 7 shows an annular stator core back component

FIG. 8 shows another example of an annular stator core back component.

FIGS. 9a-d illustrate different embodiments of cross sections of stator pole components.

FIGS. 10a-c illustrate another embodiment of a stator core.

FIG. 11 shows a one-phase cut part of an outer-rotor electric machine.

FIGS. 12a-c show views of stator parts of an outer-rotor machine with skewed claws.

FIGS. 13a illustrates another embodiment of a stator pole component. FIG. 13b illustrates another embodiment of skewed stator pole component.

FIGS. 14a-c illustrate an example of an assembly process for assembling a stator as described herein.

FIGS. 15a-d show different examples of one-phase electric machines where an example of the stator described herein are combined with different types of rotors. FIGS. 15a-c show outer rotor machines, and FIG. 15d shows an inner rotor machine.

FIG. 16 shows another embodiment of a one-phase stator.

FIGS. 17a-b show another example of a rotor.

FIGS. 18a-b show another example of an inner rotor.

### DETAILED DESCRIPTION

In the following description, reference is made to the accompanying figures, which show by way of illustration how the invention may be practiced. Throughout the drawings, like reference numerals refer to like or corresponding components, elements, and features.

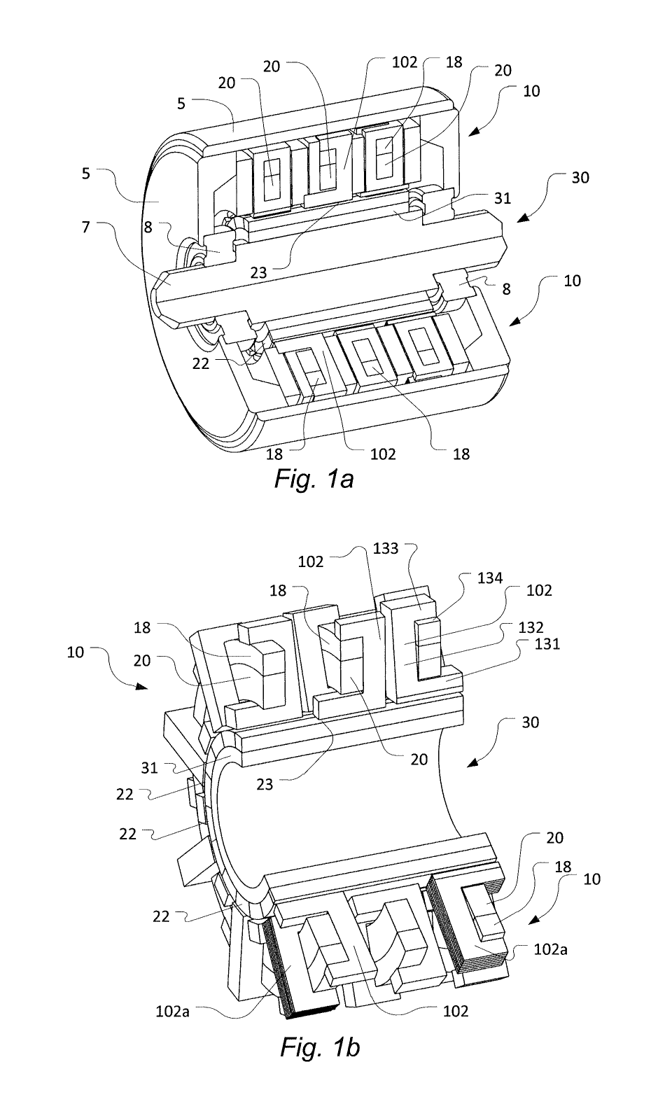

FIGS. 1a and b illustrate an example of a 3-phase inner-rotor modulated pole machine. In particular, FIG. 1a shows a perspective view of an electric machine with a portion of the machine cut away, while FIG. 1b shows a corresponding view of the magnetically active parts of the machine.

The machine comprises a housing 5, a stator 10 and a rotor 30 arranged inside the housing such that a rotor shaft 7 axially protrudes out of the housing 5, supported by bearings 8 so as to allow the rotor to rotate relative to the housing. The stator 10 and the rotor 30 are encircling a common geometric axis, defined by the rotor shaft 7. The rotor and the stator define an active air gap 23 between them so as to allow the communication of flux between the stator and rotor whilst also leaving the mechanical clearance to allow the rotor to rotate.

In the example of FIG. 1, the stator surrounds the rotor, i.e. the machine is of the inner-rotor type. However, the stator could also be placed exteriorly with respect to the rotor. Embodiments of the stator described herein may be used in single and/or in multi-phase machines. Similarly, embodiments of the stator described herein may be used in rotary machines, such as inner and outer rotor machines.

The stator 10 comprises three phases, each phase comprising a central single winding 20 that magnetically feeds a stator core. Each stator core comprises an annular stator core back component 18 and multiple stator pole components 102. The stator pole components extend radially from either side of the annular stator core back component towards the rotor, and they are arranged in an alternating fashion such that each stator pole component extending from a first side of the annular stator core back component has two circumferentially adjacent stator pole components that extend from a second side of the annular stator core back component, opposite the first side. The stator pole components of each stator phase may thus be divided into two subsets, a first subset arranged on one axial side of the winding 20 of that phase, and the second subset arranged on the opposite axial side of the winding. The stator pole components are also referred to as teeth. The stator core is formed around the winding 20 while for other common electrical machine structures windings are formed around the individual teeth.

Each stator pole component comprises a mounting part, a radially extending tooth part and an interface part. In the embodiment of FIGS. 1a-b, each stator pole component is generally L-shaped where one leg 132 of the L forms the tooth part and extends in the radial direction, and the other leg 131 of the L forms a claw that extends in the axial direction of the machine, partially or completely extending across the axial width of the winding 20. The claw 131 thus forms the interface of the stator pole component 102. In the example of FIGS. 1a-b, the axial claws 131 of the stator pole components of the first subset of stator pole components axially extend towards the radial legs 132 of the stator pole components of the second subset, thus causing the claws of the stator pole components of the two subsets of stator pole components of each phase to axially overlap. Each stator pole component 102 further comprises an axially extending protrusion that forms the mounting part of the stator pole component. The protrusion 133 extends from an end of the radial extending leg 132 opposite the end from which the claw 131 extends. In the example of FIG. 1a-b, the protrusion 133 is shorter than the claw 131. The protrusion 133 abuts a circumferential surface 134 of the annular stator core back component 18 that faces away from the air gap 23.

The rotor 30 comprises the rotor shaft 7, a tubular sleeve 31 surrounding the shaft 7, and a plurality of permanent magnets 22 surface-mounted on the outer surface of the tubular sleeve. However, as will be described below, other rotor types may be used instead. The sleeve may or may not be magnetically permeable depending on the magnetisation pattern of the permanent magnets.

The plurality of stator pole components 102, the annular stator core back component 18, and the sleeve 31 together form a closed-circuit magnetic flux path between the permanent magnets and encircling the coil 20. To this end, each stator pole component 102 may be made of laminated metal, e.g. laminated steel where the laminates are stacked in the circumferential direction, thus providing an efficient flux path in the radial and axial directions. In FIGS. 1a-b and some of the following figures, the lamination structure of the stator pole components is indicated for only some of the pole components (designated by reference numeral 102a). It will be appreciated, however, that all stator pole components may be made from such laminates. The annular stator core back component 18 may be made of a soft magnetic material, e.g. a compacted soft magnetic powder, or from a strip-wound laminate, thus providing an efficient flux path in at least the axial and circumferential directions.

The active rotor structure of rotor 30 is built up from an even number of permanent magnets 22. The permanent magnets are surface mounted, e.g.

glued or otherwise bonded, on the sleeve 31. The sleeve may be made of mild steel or another soft magnetic material thus providing mechanical support to the permanent magnets as well as a magnetic flux path between adjacent magnets. In particular, the sleeve may provide a flux path in the circumferential and radial directions. Alternatively, the sleeve may be made from compressed soft magnetic powder or another soft magnetic material.

The permanent magnets 22 are arranged so that the magnetization directions of the permanent magnets are substantially radial, i.e. the north and the south poles, respectively, face in a substantially radial direction. Further, every second permanent magnet 22, counted circumferentially has a magnetization direction in the opposite direction relative to its neighbouring permanent magnets.

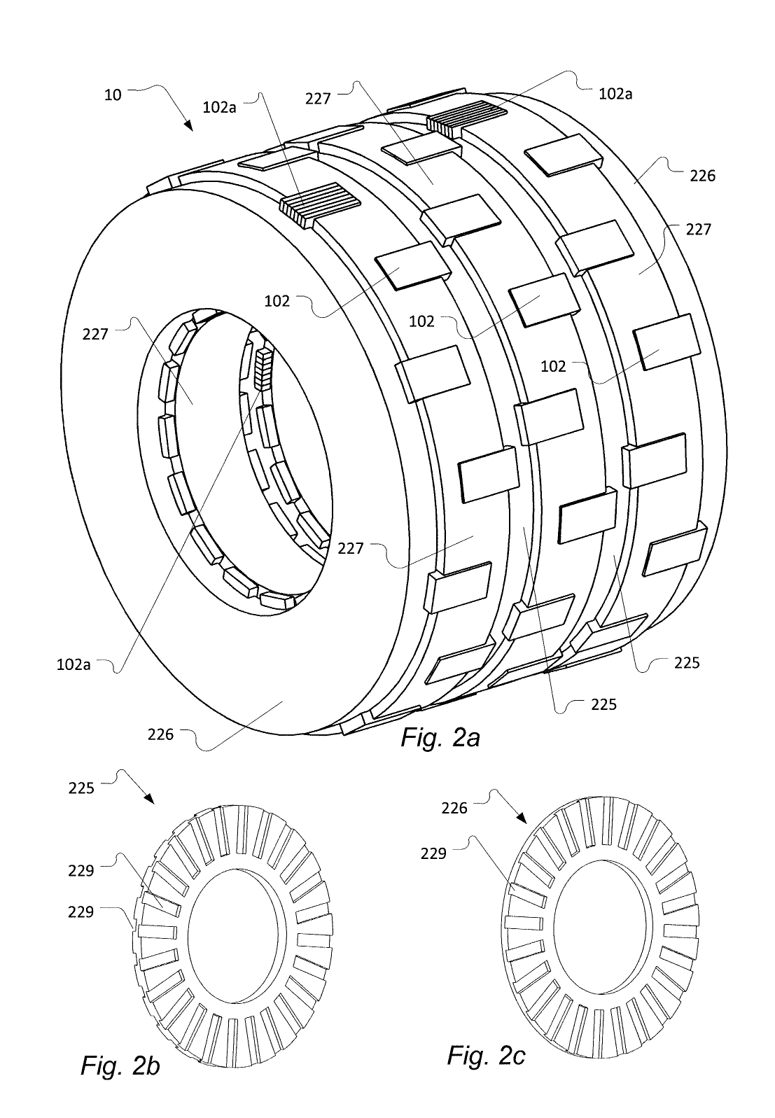

FIGS. 2a-c illustrate an example of a stator for a modulated pole machine. FIG. 2a shows a perspective view of the stator. The stator, generally designated by reference numeral 10, is similar to the stator of the electric machine of FIGS. 1a-b. The stator is a 3-phase inner-rotor stator and comprises an annular stator core back component (not explicitly shown in FIG. 2a) and a plurality of stator pole components 102, all as described in connection with FIG. 1a-b.

The different phases of the stator are axially separated by distance plates 225, and the axially outer faces of the stator are covered by end plates 226. FIG. 2b shows an example of a distance plate while FIG. 2c shows an example of an end plate. The faces of the distance plates 225 and/or the inward faces of the end plates 226 may comprise recesses 229 and/or other suitable positioning/indexing features for simpler assembly and mutual alignment of the stator components. The distance plates 225 and end plates 226 may be made of any suitable material, e.g. non-magnetic material such as aluminium or plastics. In some embodiments of a multi-phase machine, the different phases may not be separated by distance plates. The space between the stator pole components is filled with a suitable material 227, e.g. plastic or another non-magnetic material. For example the material may be deposited by a suitable moulding process e.g. an over moulding process, where the end plates and distance plates form a part of the mould. The end plates 226 may be connected to each other by axially extending bolts, screws or the like, allowing the stator components sandwiched between the end plates to be secured and/or pressed together.

In some embodiments, the different phases may be separately produced and assembled. In the over-moulding process the distance plate 225 may be made together with the over-moulding material 227; this reduces the number of components at the assembling process.

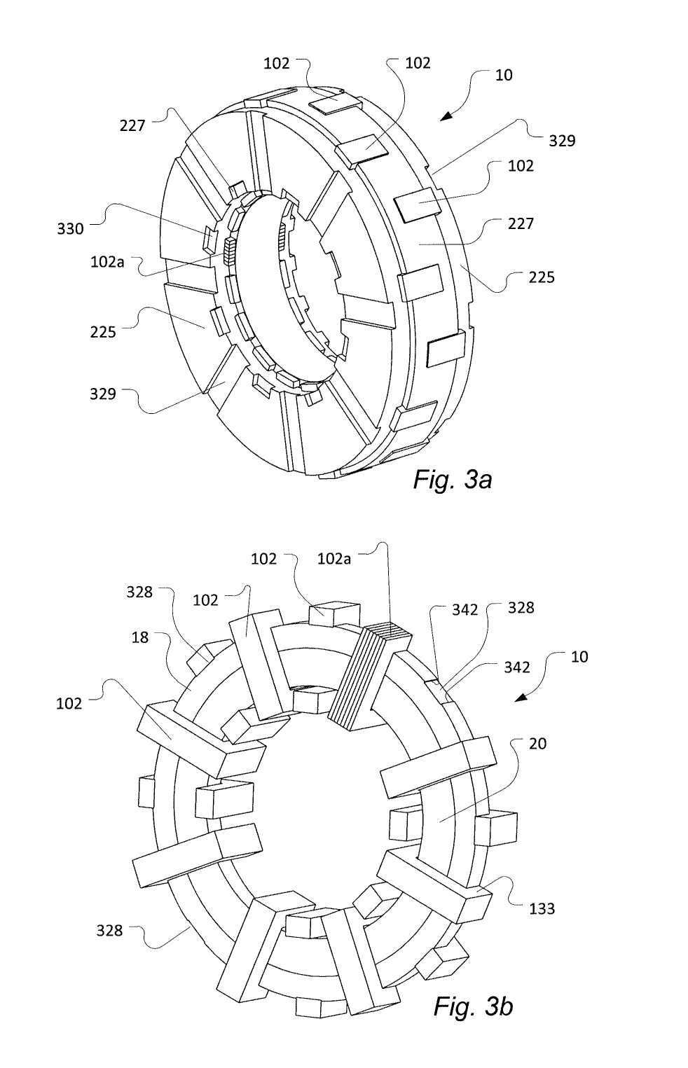

FIGS. 3a-b show an example of a single-phase stator. In particular, FIG. 3a shows a perspective view of a stator, while FIG. 3b shows a corresponding view of the magnetically active parts of the stator, but with some of the stator pole components removed to allow a clearer view of the features obstructed from view by the stator pole components. The stator, generally designated by reference numeral 10, is a single-phase inner-rotor stator, similar to the central phase of the stator shown in FIG. 2. The stator 10 comprises an annular stator core back component 18, and winding 20, and a plurality of stator pole components 102 all as described in connection with FIG. 2 and FIGS. 1a-b. The stator 10 of FIGS. 3a-b may be used as a stator of a single-phase machine or as a phase of a multi-phase stator. The axially outer faces of the stator are covered by end plates 225. The space between the stator pole components is filled with a suitable material, e.g. plastic or another non-magnetic material, all as described in connection with FIG. 2. When the stator 10 of FIG. 3a is to be used as a central phase of the stator of FIG. 2, the end plates 225 of the stator of FIG. 3a may function as distance plates of a 3-phase stator. To this end, the laterally outward faces of the end plates 225 may have recesses 329 and 330 (or other suitable positioning/indexing features) for receiving corresponding stator pole components of a neighbouring stator phase, thus allowing for a simpler assembly and mutual alignment of the stator components.

The annular stator core back component 18 comprises recesses 328 on its surface facing away from the air gap. The recesses are distributed around the circumference of the annular stator core back component, and each recess has a shape and size so as to receive a protrusion 133 of respective ones of the stator pole sections 102. In the example of FIG. 3b the recesses are distributed equidistantly along the circumference; however in other embodiments, the distance between recesses may differ. The recesses allow an precise and easy assembly of the stator pole components 102 with the annular stator core back component. Each recess defines a plane contact surface to which a corresponding contact surface of a protrusion 133 can abut. The contact surface of the recess is delimited by side walls 342 that define the circumferential position of a stator pole component. It will be appreciated that the annular stator core back component may comprise different indexing features in addition or alternative to the recesses 328.

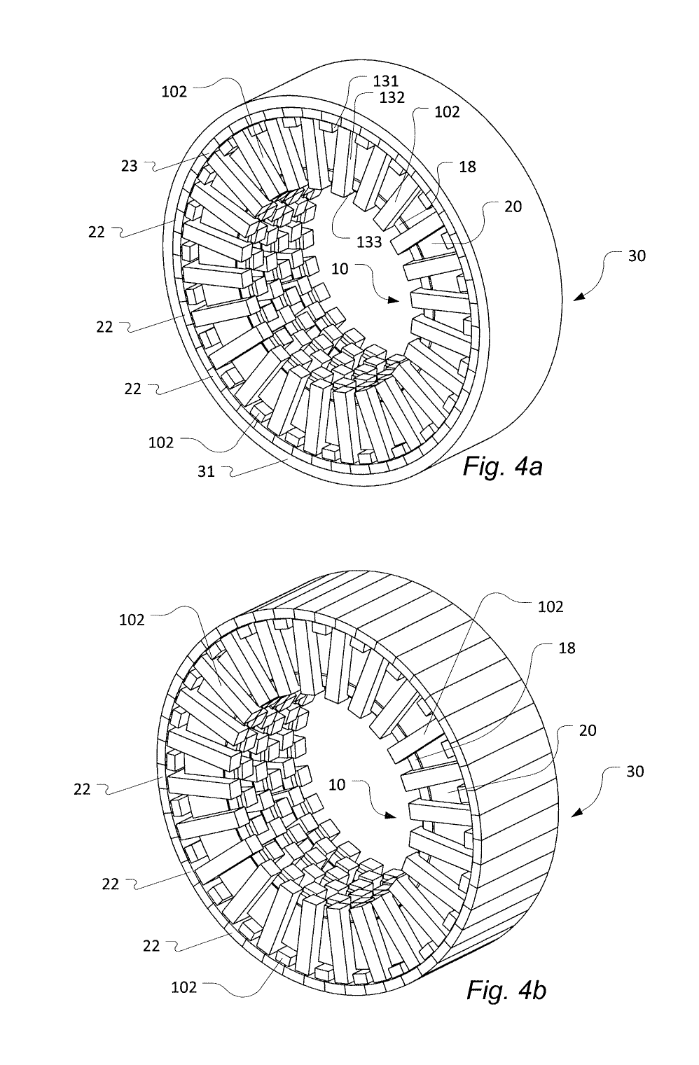

FIGS. 4a-b show an example of a 3-phase outer-rotor electric machine. In particular, FIG. 4a shows a perspective view of parts of the machine including the magnetically active parts, while FIG. 4b shows the same view as FIG. 4a, but with the outer sleeve of the rotor removed.

The machine comprises a stator 10 and a rotor 30 having a common axis such that the rotor encircles the stator. The rotor and the stator define an active air gap 23 between them allowing magnetic flux to communicate between the stator and the rotor.

The stator comprises three phases, each phase comprising a central single winding 20 that magnetically feeds a stator core. Each stator core comprises an annular stator core back component 18 and multiple stator pole components 102. The stator pole components extend radially from either side of the annular stator core back component towards the rotor, and they are arranged in an alternating fashion such that each stator pole component extending from a first side of the annular stator core back component has two circumferentially adjacent stator pole components that extend from a second side of the annular stator core back component, opposite the first side. The stator pole components of each stator phase may thus be divided into two subsets, a first subset arranged on one axial side of the winding 20 of that phase, and the second subset arranged on the opposite axial side of the winding. The stator pole components are also referred to as teeth.

As in the embodiment of FIG. 1a-b, each stator pole component may be generally L-shaped where one leg 132 of the L extends in the radial direction, and the other leg 131 of the L forms a claw that extends in the axial direction of the machine, partially or completely extending across the axial width of the winding 20. The stator pole component further comprises a mounting part, e.g. in the form of an axially extending protrusion 133 that extends from an end of the radial extending leg opposite the end from which the claw extends.

The rotor 30 comprises a tubular sleeve 31and a plurality of permanent magnets 22 surface mounted on the inner surface of the tubular sleeve, as described in connection with FIGS. 1a-b, but for an outer-rotor structure.

In some embodiments, the outer sleeve 31 may be magnetically active, i.e. in such an embodiment all the components shown in FIG. 4a are magnetically active. In other components, e.g. when the magnetisation pattern of the magnets is of Hallbach array type, the outer sleeve is not magnetically active, but may still be present so as to provide mechanical support to the rotor.

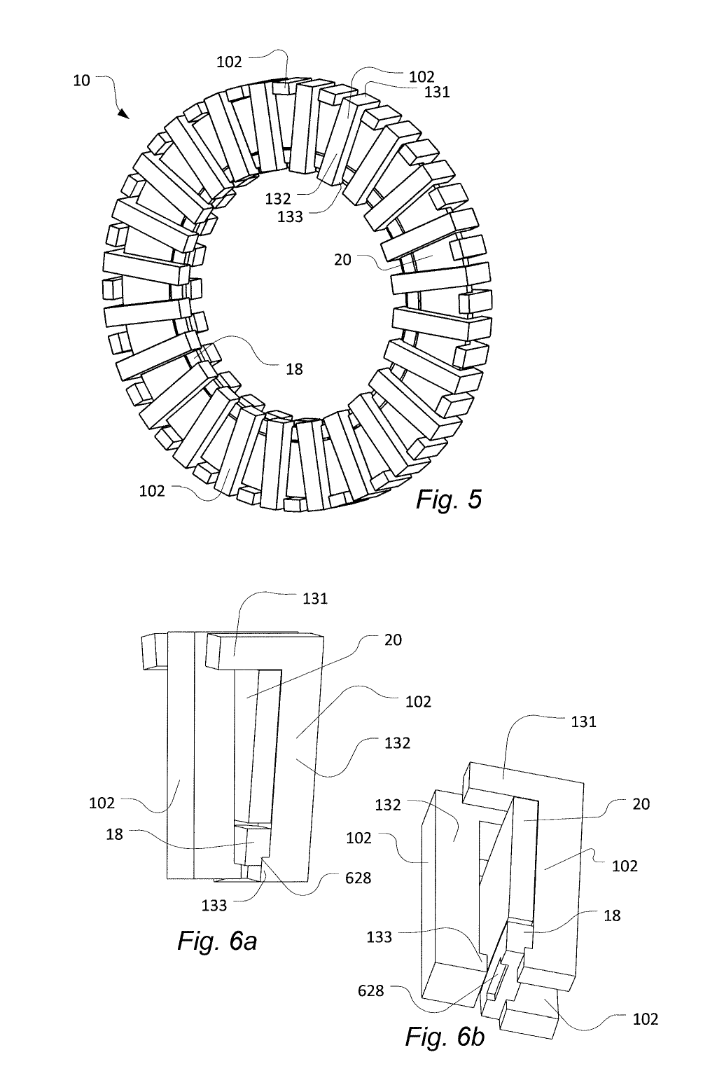

FIG. 5 shows an example of a single-phase stator for an outer-rotor electric machine, e.g. a phase of the three-phase stator of FIGS. 4a-b.

The stator 10 comprises a central single winding 20 that magnetically feeds a stator core. The stator core comprises an annular stator core back component 18 and multiple stator pole components 102. The stator pole components extend radially from either side of the annular stator core back component towards the rotor, and they are arranged in an alternating fashion, as described in connection with FIGS. 4a-b.

Each stator pole component is generally L-shaped where one leg 132 of the L forms a radially extending tooth part, and the other leg 131 of the L forms an axially extending claw part, as described above. The stator pole component further comprises a mounting part in the form of an axially extending protrusion 133 that extends from an end of the radial extending leg opposite the end from which the first axial leg extends. The protrusion 133 allows the stator pole component to interlock with a corresponding indexing feature of the annular stator core back component 18.

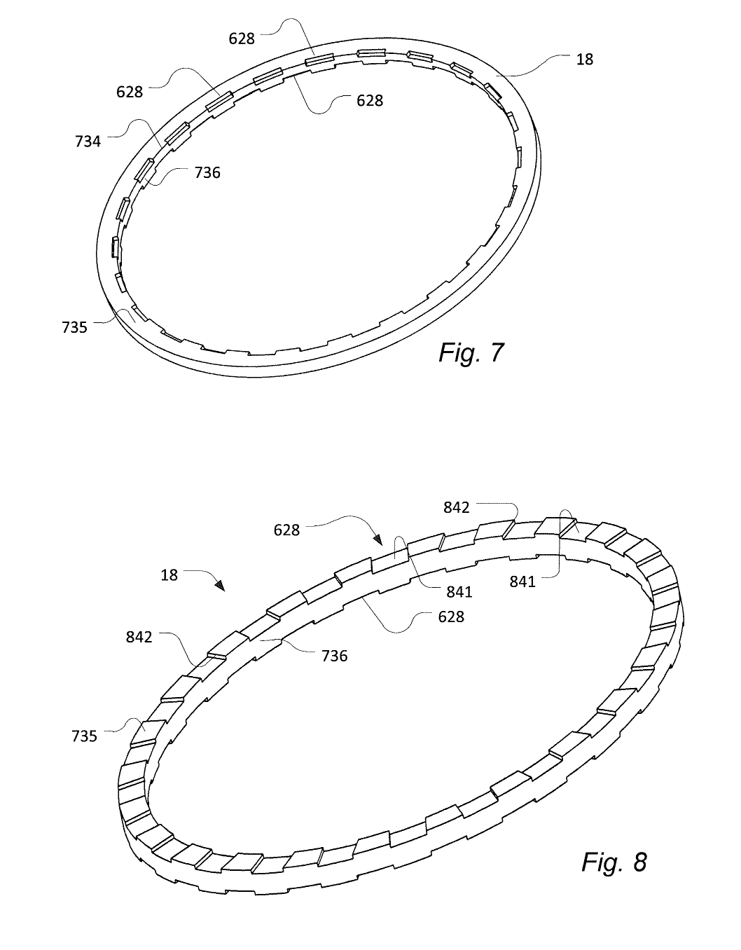

FIGS. 6a-b show a more detailed view of a part of the stator of FIG. 5, while FIG. 7 shows an example of an annular stator core back component 18, e.g. the annular stator core back component shown in FIGS. 5 and 6a-b. In particular, FIGS. 6a-b each show three of the stator pole components 102 and corresponding parts of the winding 20 and the annular stator core back component 18. FIGS. 6a and 6b show cut views, where the cuts are made in the centre of respective teeth.

FIG. 6b is a partially exploded view, where one of the stator pole components is shown axially displaced so as to more clearly show details of the annular stator core back component 18. In particular, the annular stator core back component 18 comprises recesses 628 distributed on both axial sides around the circumference of the annular stator core back component 18. Each recess 628 receives the axial protrusion 133 of one of the stator pole components, thus allowing an accurate positioning of the stator pole components 102 along the circumference of the annular stator core back component 18. In the example of FIG. 7, the recesses are placed at the edges 734 formed by the axially oriented side faces 735 of the annular stator core back component with the face 736 radially oriented away from the active air gap, i.e. in the case of an outer-rotor machine, the radially inwardly oriented face.

FIG. 8 shows another example of an annular stator core back component. The annular stator core back component 18 comprises recesses 628 distributed on both axial sides around the circumference of the annular stator core back component 18. Each recess 628 receives a radially extending leg of the stator pole components, thus allowing an accurate positioning of the stator pole components along the circumference of the annular stator core back component 18. In the example of FIG. 8, each recess extends across the entire radial width of the axially oriented side faces 735 of the annular stator core back component. The side walls 842 of the recesses prevent the stator pole component from being circumferentially displaced and facilitate an accurate positioning of the stator pole components along the circumference of the annular stator core back component. The bottom faces 841 of the recesses provide a planar abutment surface to which the stator pole component can abut.

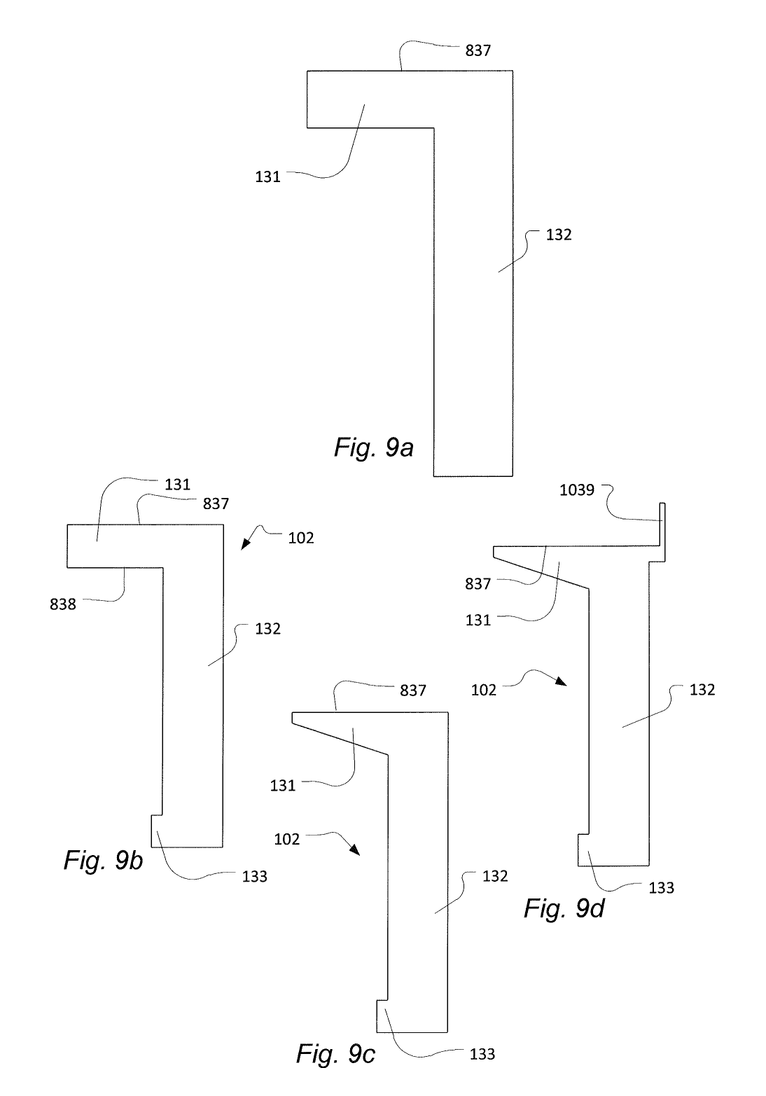

The annular stator core back component 18 of FIG. 8 may be used together with stator pole components of different shapes, e.g. an L-shaped stator pole component as shown in FIG. 9a below without an axial protrusion at its mounting part, or with an L-shaped stator pole component as shown in FIG. 9b below with an axial protrusion at its mounting part. In the former case, a fixation of the stator pole component in radial direction may be achieved by suitable indexing features in an endplate or distance plate, or in an assembly mould. The stator pole components may then be prevented from radial displacement by an overmoulding material. In the latter case, an axial protrusion of the stator pole component may abut with the radially oriented face 736 of the annular stator core back component, thus causing the stator pole component to interlock with the annular stator core back component in both circumferential and in radial direction.

FIGS. 9a-d illustrate different embodiments of cross sections of stator pole components. The stator pole components are generally L-shaped comprising a leg 132 that extends in the radial direction of the stator, and a leg 131 that extends in the axial direction of the stator. The radial leg provides a radial magnetic flux path from the annular stator core back component towards the rotor, while the axial leg 131 forms a claw that provides an axial flux path from the radial leg across the axial width of the active air gap. The axial leg thus provides an interface surface 837 facing the air gap. In an inner-rotor machine, the interface surface 837 faces radially inwards, and in an outer-rotor machine, the interface surface 837 faces radially outwards.

The stator pole component of FIGS. 9b-d further comprises a protrusion 133 protruding from the radial leg 132 in the axial direction of the stator. The protrusion is located at the end of the leg 132 distal to the end from which the leg 131 extends. As described above, protrusion 133 allows the stator pole component 102 to interlock with a recess of the annular stator core back component. It will be appreciated that other indexing features may be provided alternatively or additionally to the protrusion. Such alternative or additional indexing features may engage corresponding indexing features of the annular stator core back component, so as to allow accurate positioning of the stator pole components, and to prevent radial and/or axial displacement of the stator pole components, e.g. due to the magnetic forces from the rotor permanent magnets. The protrusion further increases the area of the contact surface between the stator pole component and the annular stator core back component, thus facilitating an efficient transfer of the magnetic flux. This may be particularly beneficial when the stator pole component is made of laminated material of high permeability and the annular stator core back component is made of a material of lower permeability.

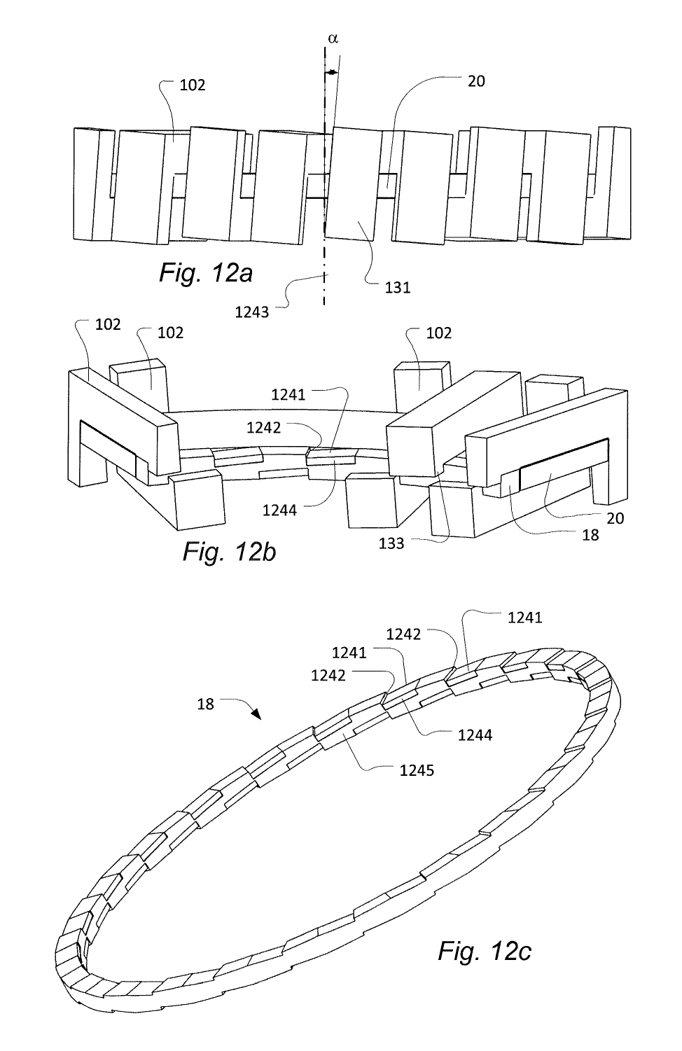

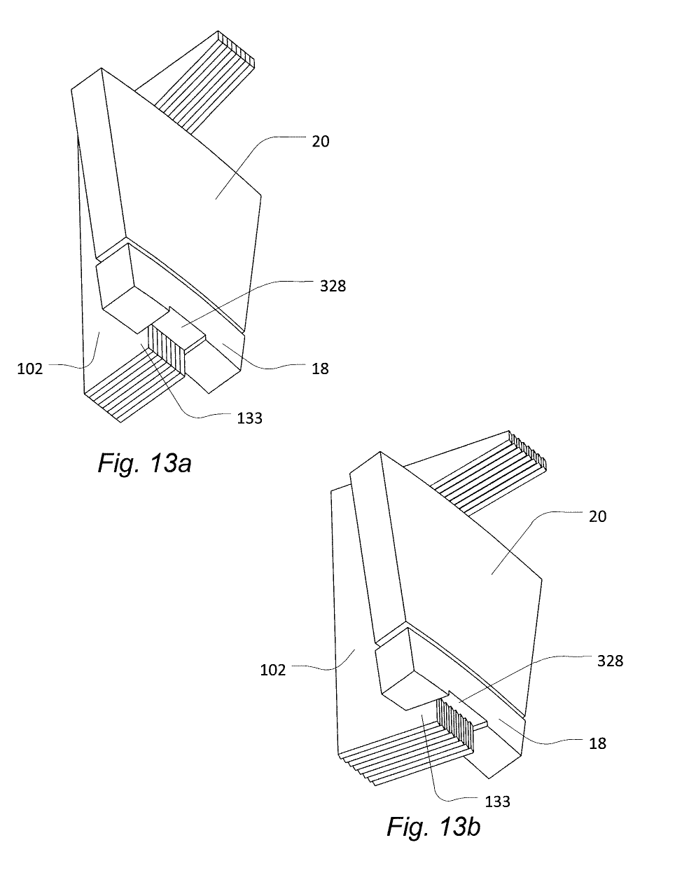

The stator pole component of FIG. 9a does not comprise any protrusion extending from the legs 131 and 132 of the L-shaped stator pole component. A fixation of the stator pole component in radial direction relative to the stator core back component, e.g. stator core back component 18 of FIG. 8 or FIG. 12c, a fixation of the stator pole component in radial direction may be achieved by suitable indexing features in an endplate or distance plate, or in an assembly mould. The stator pole components may then be prevented from radial displacement by an overmoulding material.

The axially extending claw 131 may be shaped in different ways. In the example of FIGS. 9a-b, the claw 131 has a constant radial width across its axial extent, while the claw 131 of FIGS. 9c and 9d are tapered such the radial width of the leg decreases with increasing distance from the radial leg 132. As the claw 131 communicates magnetic flux along the axial extent of the interface surface 837 the amount of flux flowing from/towards the leg 132 increases with decreasing distance from the leg 132. Hence, an increasing radial width of the claw 131 requires less material while at the same time providing sufficient cross section for the magnetic flux. Consequently, this embodiment provides a lower weight while maintaining good magnetic properties and a high stability against radial forces.

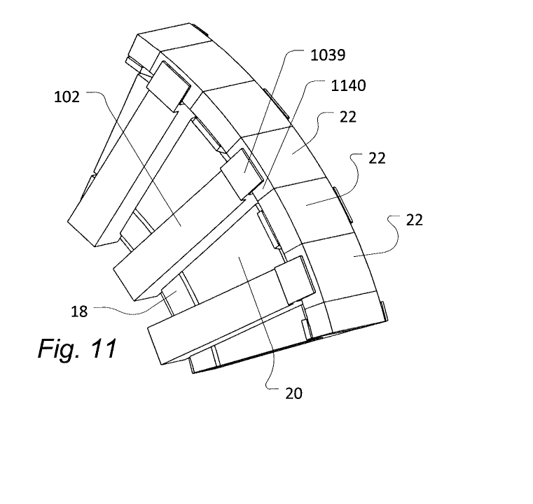

As shown in the example of FIG. 9d, the stator pole component may further comprise a radially protruding part that protrudes radially in the direction towards the rotor at the same end of leg 132 as the axial claw 131. The claw 131 and the radially protruding part 1039 extend from axially opposite sides of leg 132, and the radially protruding part 1039 extends along a lateral side face of the permanent magnets 22 of the rotor, as illustrated in FIG. 11. FIG. 11 shows a part of an outer-rotor electric machine where the stator pole components 102 have a profile as shown in FIG. 9d. The radially extending part 1039 allows magnetic leakage flux that may occur at the axial edges 1140 of the permanent magnets 22 to be transferred to the stator pole component and thus utilised by the electric machine.

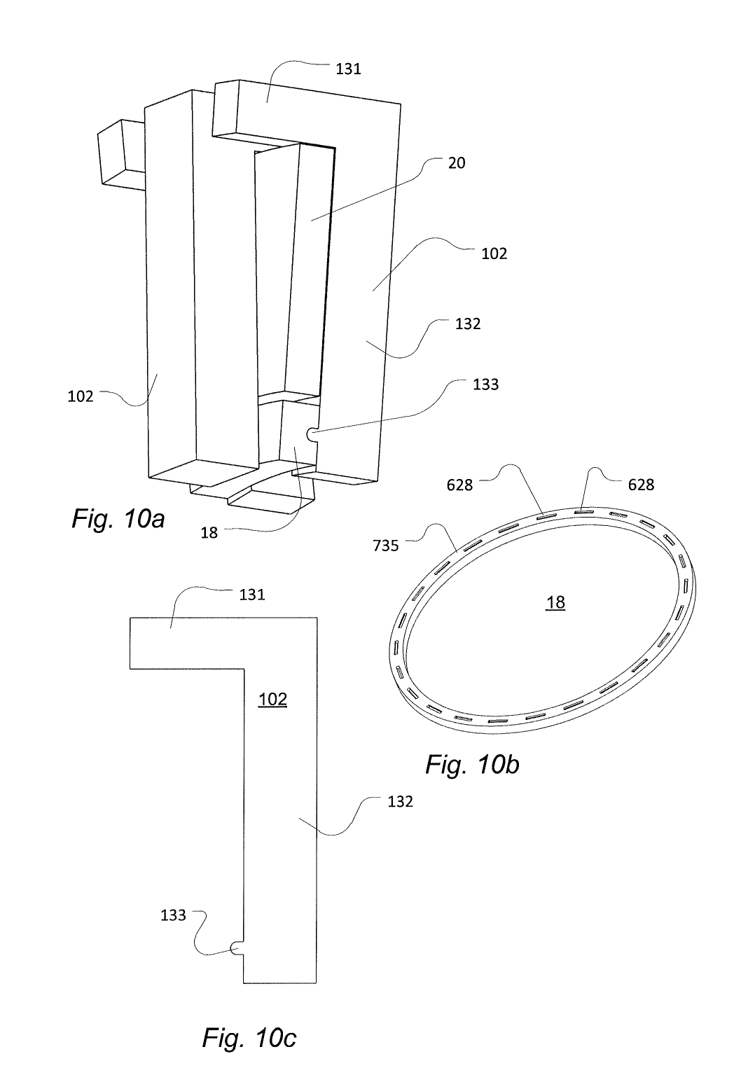

FIGS. 10a-c illustrate another embodiment of a stator core. FIG. 10a shows a detailed cut view of a part of the stator where the cuts are made in the centre of respective teeth. The stator of FIG. 10a is similar to the stator described in connection with FIGS. 5 and 6a-b, in that the stator comprises a central single winding 20 that magnetically feeds a stator core. The stator core comprises an annular stator core back component 18 and multiple stator pole components 102. The stator pole components extend radially from either side of the annular stator core back component towards the rotor, and they are arranged in an alternating fashion. Each stator pole component is generally L-shaped where one leg 132 of the L forms a radially extending tooth part, and the other leg 131 of the L forms an axially extending claw part, as described above, all as described in connection with FIGS. 5. FIG. 10b shows the annular core back component of the stator core, while FIG. 10c shows a side view of one of the stator pole components of the stator.

The stator pole component 102 further comprises a mounting part in the form of an axially extending protrusion 133 that extends from the radial extending leg proximal to the end opposite the end from which the first axial leg extends. The protrusion 133 allows the stator pole component to interlock with a corresponding indexing feature 628 of the annular stator core back component 18.

In particular, the annular stator core back component 18 comprises recesses 628 distributed on both axial sides around the circumference of the annular stator core back component 18. Each recess 628 receives the axial protrusion 133 of one of the stator pole components, thus allowing an accurate positioning of the stator pole components 102 along the circumference of the annular stator core back component 18. The protrusion may have the form of a ridge extending across the entire width of the stator pole component. In particular, when the stator pole component is made of laminated metal sheets this allows the laminates to have a uniform shape. The ridge may have a cross section with a round, e.g. semi-circular, top.

In the example of FIGS. 10a-c, the recesses 628 are placed in the axially oriented side faces 735 of the annular stator core back component. The recesses may have the form of an elongated depression, elongated in the circumferential direction and having a length and width allowing a snug fit of the recess 133 into the depression. The depression may radially be located at or close to the centre of the side faces 735. The annular core back component with this type of depressions allows for a particularly cost-efficient manufacturing as an SMC component. Furthermore, the side face 735 provides a planar abutment surface for the stator pole components thus providing a reliable mounting and an efficient magnetic interface.

In the embodiments described above, the axially extending claws of the L-shaped stator pole components are parallel with the axis of the machine. In the following, embodiments of stators will be described in which the axially extending claws are skewed, i.e. form an angle relative to the axis of the machine. Such skewing of the claws reduces undesired cogging torque of the electric machine.

FIGS. 12a-c show views of a stator of an outer-rotor machine with skewed claws. FIG. 12a shows a radial view of the stator, while FIG. 12b shows a perspective view of the stator with some of the stator pole sections removed so as to provide an unobstructed view of details of the annular stator core back component. FIG. 12c shows the annular stator core back component of the stator. The stator is similar to the stator shown in FIG. 5 and comprises an annular stator core back component 18, stator pole components 102 and a winding 20 as described connection with the above embodiments. However, in the embodiment of FIG. 12, the axially extending legs 131 forming the claws of the stator pole sections 102 are oriented at an angle a relative to the axis 1243 of the stator. The skewing is obtained by providing the annular stator core back component 18 with suitable indexing features that define a slanted surface 1241 on an axial side face of the annular stator core back component which surface terminates at an axial end wall 1242. The end wall 1242 defines a circumferential position at which the stator pole component is to be located while the slanted surface 1241 defines the skewing angle of the stator pole component. Furthermore, the radially inwardly oriented cylindrical surface 1245 of the annular stator core back component 18 comprises plane abutment surfaces 1244 to which the axially extending protrusions 133 of the stator pole sections can abut.

FIG. 13 illustrates another embodiment of skewed stator pole components. FIG. 13a shows a part of a stator for an outer-rotor machine. In particular FIG. 13a shows one of the laminated stator pole components 102, a part of the annular stator core back component 18, and a part of the winding 20. The annular stator core back component 18 comprises an indexing feature 328 for receiving an axial protrusion 133 of the stator pole component 102. FIG. 13b shows a similar stator, but with skewed claws of the stator pole component 102. In this example, the skewing is provided by the laminate rather than defined by the indexing feature 328. In particular, the individual sheets of the laminate are slightly displaced relative to each other so as to define a skewed edge of the leg 132.

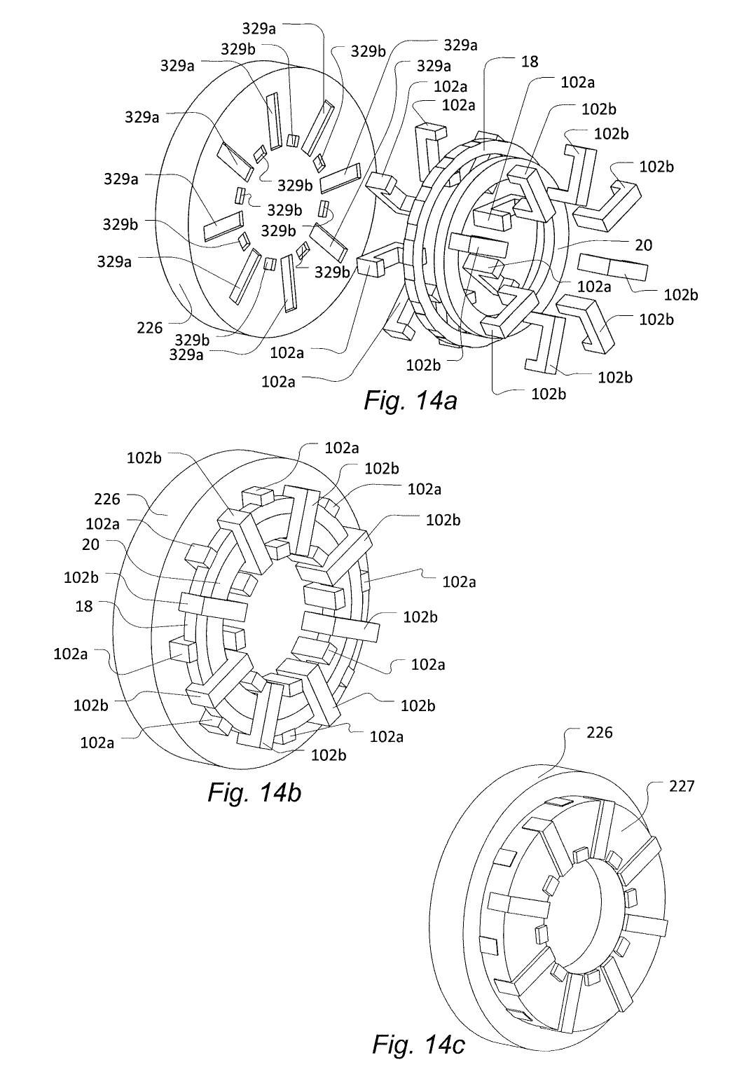

FIGS. 14a-c illustrate an example of an assembly process for assembling a stator as described herein, e.g. a stator for an inner-rotor machine. The stator comprises an annular stator core back component 18, a winding 20, a plurality of stator pole components 102a,b, and two end plates 226, only one of which is shown in FIGS. 14a-c. FIG. 14a shows an exploded view of the stator components prior to assembly. FIG. 14b shows the assembled stator components, while FIG. 14c shows the assembled stator after an over-molding step.

The end plate 226 comprises a plurality of indexing features 329a,b in the form of recesses sized and shaped to receive respective ones of the stator pole components 102a,b. A first subset 329a of the indexing features are sized and shaped to receive a first subset 102a of the stator pole components that are located on a first side of the winding 20 and of the annular stator core back component 18. A second subset 329b of the indexing features are sized and shaped to receive a second subset 102b of the stator pole components that are located on a second side of the winding 20 and of the annular stator core back component 18, opposite the first side. During assembly, the first subset 102a of stator pole components are initially positioned on the end plate 226, using the indexing features 329a for accurate positioning. Subsequently, the winding 20 and annular stator core back component 18 are positioned on the stator pole components 102a, e.g. using indexing features of the annular stator core back component 18 to facilitate accurate positioning. It will be appreciated that in some embodiments only the end plates/distance plates may be provided with indexing features while in other embodiments only the annular stator core back component may be provided with indexing features. In yet further embodiments the end plates/distance plates and the annular stator core back component are both provided with indexing features.

Subsequently, the second subset 102b of the stator pole components may be assembled onto the already assembled components, using the indexing features 329b and optionally indexing features of the annular stator core back component to facilitate accurate assembly. The resulting assembly is shown in FIG. 14b. Finally, a second end plate (not shown), optionally comprising the same indexing features as the first end plate may be mounted, and the assembled stator may be overmolded by a suitable material 227, e.g. plastic.

It will be appreciated that a similar assembly method may be performed for outer-rotor machines and/or for multi-phase machines. In the latter case, the individual phases may be separated by distance plates with indexing features on both sides. The assembly may thus be performed successively one phase at a time, where the stator components of a subsequent phase are assembled onto the distance plate of the already assembled phase. It will further be appreciated that the assembly process may be modified in various ways. For example in addition to or alternatively to the overmolding, the end plates may be secured to each other by axial screws or other fastening means allowing to press the stator component together axially.

It is thus an advantage of embodiments of the stator described herein that it allows the components to be assembled by applying an axial pressure. Furthermore, it allows an assembly by applying a pressure so as to press planar surfaces together. Consequently, embodiments of the stator described herein provide a close contact between the stator pole componnets and the annular stator core back component which in turn provides good magnetic properties and high mechanic stability.

In yet an alternative embodiment the end plates 226 may during the assembly process be replaced by an assembly mold. Such an assembly mold may have indexing features similar to the indexing features 329a,b shown in connection with end plate 226. The assembly mold may thus provide a mounting surface and be used in a similar fashion as described above with reference to the end plate 226 so as to facilitate assembly of the stator pole components, the winding, and the annular stator core back component. After completion of the assembly process, including an optional overmolding step, the assembly mold may be removed or replaced by end plates.

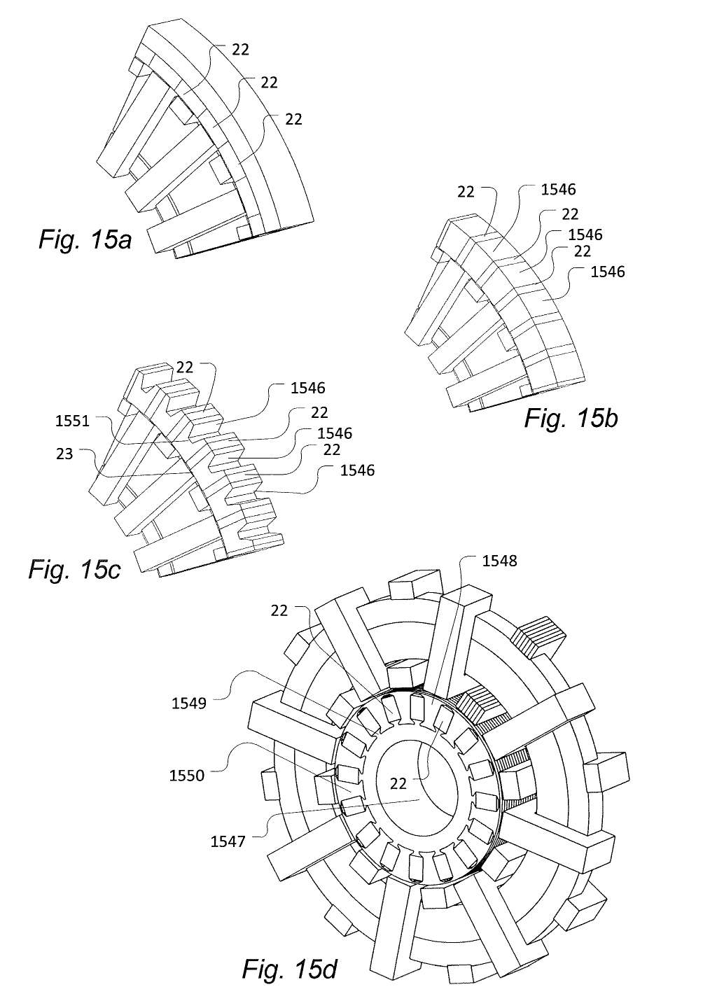

FIGS. 15a-d show different examples of electric machines where an example of the stator described herein is combined with different types of rotors.

FIG. 15a shows an example of a machine comprising a rotor having surface-mounted magnets 22 that are magnetized in the radial direction. Such a rotor construction allows for the use of relatively inexpensive ferrite magnets as the reduced strength of the magnets may be compensated by increasing the radial thickness of the magnets. In an outer-rotor machine a rotor with surface-mounted magnets may be particular beneficial for smaller rotor diameters.

FIG. 15b shows an example of a machine comprising a rotor having circumferentially magnetized magnets 22, separated in the circumferential direction from each other by soft-magnetic rotor pole pieces 1546 for concentrating the magnetic flux from said permanent magnets, e.g. as disclosed in WO 2007/024184.

FIG. 15c shows an example of a machine comprising a rotor having circumferentially magnetized magnets 22, separated in the circumferential direction from each other by soft-magnetic rotor pole pieces 1546 for concentrating the magnetic flux from said permanent magnets. The stator defines the axial limits of the air gap 23 between the stator and the rotor for communicating magnetic flux between the stator and the rotor. The pole pieces have contact surfaces, each abutting a corresponding contact surface of a respective neighboring permanent magnet, and a central part 1551 between the contact surfaces. The central part 1551 has a radial thickness smaller than a radial thickness of the corresponding neighboring permanent magnets. Alternatively or additionally, the central part may have an axial length smaller than an axial length of the neighboring permanent magnets. This may e.g. be beneficial when the permanent magnets have an axial extent larger than the axial extend of the active air gap as defined by the magnetically active stator structure, e.g. as disclosed in WO2009/116937.

FIG. 15d shows an inner rotor machine comprising a rotor with buried magnets. The rotor comprises a tubular support member 1547 surrounded by a tubular flux guiding member 1548 that provides a flux path in the circumferential and radial direction. The flux guiding member 1548 comprises axially extending cavities in which respective permanent magnets 22 are disposed. The permanent magnets are magnetized in the circumferential direction with every second magnet magnetized in the opposite direction. The flux guiding member may form an outer tubular support structure surrounding the permanent magnets, and it may be made of laminated metal, laminated in the axial direction, thereby providing an efficient flux path and structurally supporting the permanent magnets against centrifugal forces. The rotor comprises a plurality of spoke members 1550 extending radially outwards from the inner tubular support structure 1547 and separating adjacent permanent magnets in the circumferential direction. The inner support structure 1547 may be made of non-magnetic material such as aluminium or plastic. In the example of FIG. 15d, the inner support member comprises axially extending ridges 1549, e.g. radially protruding extrusions of the inner support member, on which the permanent magnets are disposed. The ridges support the torque loads. The magnets may be glued to this structure, but since the large laminated ring 1548 supports the magnets in the radial direction, an additional fixation of the magnets may not be necessary.

The rotor of FIG. 15d is particularly well-suited for high speed applications where the rotor is operated at high rotational speed. In an alternative embodiment, the rotor may comprise additional flux guiding members located circumferentially adjacent to the buried magnets 22 and providing a flux path in the circumferential and axial direction, e.g. as described in co-pending International application no. PCT/EP2011/065905. Such a rotor would thus provide axial flux concentration in the rotor and can be used with a stator where the stator pole components have no or only small claws. The additional flux guiding members may be made of laminate laminated in the radial direction, or of another soft magnetic material, e.g. compacted soft magnetic powder.

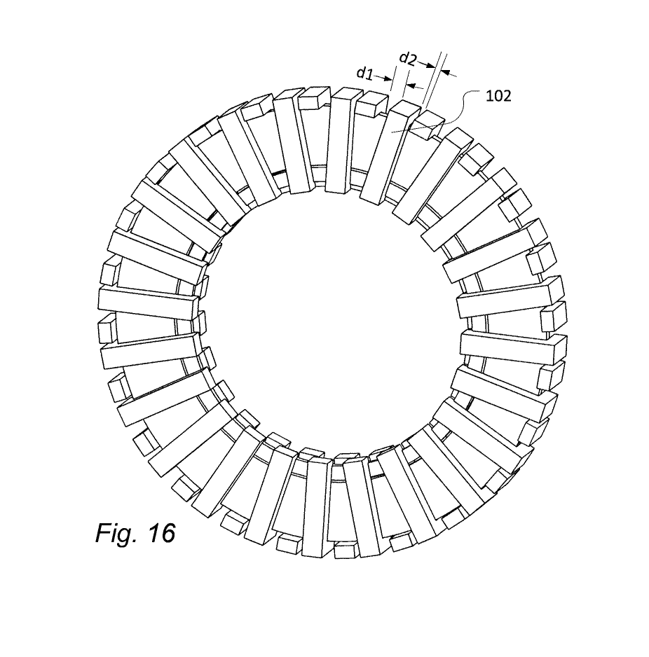

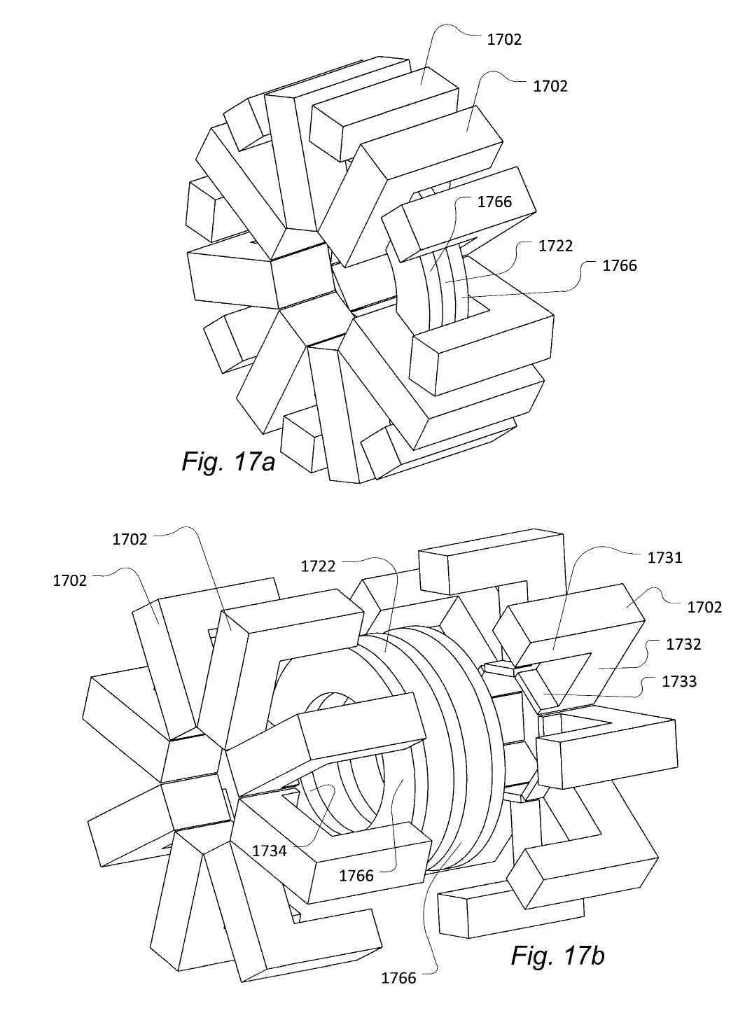

FIG. 16 shows another embodiment of a stator, where the stator pole components are distributed such that they have varying distance to their respective adjacent stator pole sections, i.e. by so-called pitching of the stator pole elements. In the example of FIG. 16 the stator pole elements 102 have a distance d1 to their neighbour on one side and a different distance d2 to their neighbour on the other side. Such pitching reduces undesired cogging torque and may be provided in a simple manner in embodiments of the stator disclosed herein without adding any significant complexity to the stator manufacturing. For example, pitching of the stator pole components may be used to reduce undesired cogging torque in the stator of FIGS. 10a-c.

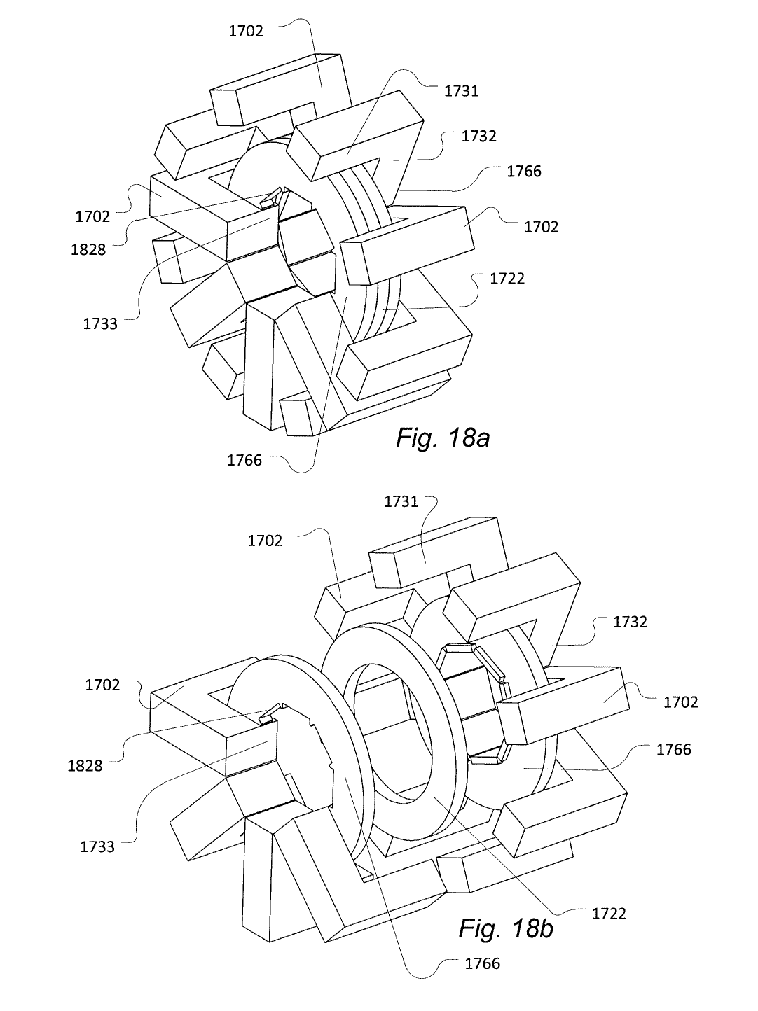

FIGS. 17a-b show another example of an inner rotor. FIG. 17a shows a perspective view while FIG. 17b shows an exploded view of the rotor. The rotor is built on the same principle as embodiments of the stators described herein. The rotor of FIG. 17 is of the inner-rotor type, but it will be appreciated that an outer rotor may be constructed using the same principles.

The rotor comprises an annular permanent magnet 1722 that is magnetised in the axial direction. On each side of the magnet 1722 there are annular rotor core back components in the form of annular soft magnetic discs 1766 carrying 3-dimensional flux from the magnet into the teeth 1732 and 1733. The discs may be manufactured as SMC components, and they allow flux concentration to be utilised in the rotor. The discs 1766 function as the rotor core-back having the same functionality for the rotor as the stator core-back described above has in connection with the stator.

The rotor further comprises multiple rotor pole components 1702. The rotor pole components extend radially from either side of the annular permanent magnet towards the stator, and they are arranged in an alternating fashion such that each rotor pole component extending from a first side of the annular permanent magnet has two circumferentially adjacent rotor pole components that extend from a second side of the annular permanent magnet, opposite the first side. The rotor pole components may thus be divided into two subsets, a first subset arranged on one axial side of the permanent magnet 1722, and the second subset arranged on the opposite axial side of the permanent magnet.

Each rotor pole component comprises a mounting part, a radially extending tooth part and an interface part. In the embodiment of FIGS. 17a-b, each rotor pole component is generally L-shaped where one leg 1732 of the L forms the tooth part and extends in the radial direction, and the other leg 1731 of the L forms a claw that extends in the axial direction of the rotor. The claw 1731 thus forms the interface of the rotor pole component 1702. In the example of FIGS. 17a-b, the axial claws 1731 of the rotor pole components of the first subset of rotor pole components axially extend towards the radial legs 1731 of the rotor pole components of the second subset, thus causing the claws of the rotor pole components of the two subsets of rotor pole components to axially overlap. Each rotor pole component 1702 further comprises an axially extending protrusion 1733 that forms the mounting part of the rotor pole component for coupling the rotor pole component to respective ones of the discs 1766 and/or directly to the permanent magnet. The protrusion 1733 extends from an end of the radial extending leg 1732 opposite the end from which the claw 1731 extends. In the example of FIG. 17a-b, the protrusion 1733 is shorter than the claw 1731. The protrusion 1733 abuts a circumferential surface 1734 of the disc 1766 that faces away from the air gap.

Hence, the structure of the rotor of FIG. 17 is similar to the structure of the stator described herein and may efficiently be manufactured. The rotor pole components 1702 may be made from an SMC material or from laminated metal sheets, as described in connection with the stator pole components described herein.

The discs 1766 provide a magnetic flux path between the permanent magnet 1722 and the rotor pole component 1702, and they provide mechanical support to the rotor pole components 1702. To this end, the discs 1776 may comprise the same or similar types of features as described in connection with the embodiments of the annular stator core back element described above. For example, the discs 1766 may be provided with indexing elements configured to engage with the mounting part of respective ones of the rotor pole components, e.g. as shown in the example of FIGS. 18a-b.

FIGS. 18a-b show another example of an inner rotor. FIG. 18a shows a perspective view while FIG. 18b shows an exploded view of the rotor. In FIGS. 18a-b some of the rotor pole components have been omitted so as to allow an unobstructed view of the annular permanent magnet 1722 and the discs 1766. The rotor of FIGS. 18a-b is similar to the rotor of FIGS. 17a-b, but with the discs 1766 comprising indexing features 1828 adapted to mate with corresponding axial protrusions 1733 of the rotor pole components. In the example of FIGS. 18a-b, the indexing features 1828 have the form of recesses distributed along the rim of the central hole of the discs 1766 that faces away from the air gap. Each recess has a shape and size so as to receive a protrusion 1733 of respective ones of the rotor pole sections 1702. In the example of FIGS. 18a-b the recesses are distributed equidistantly along the circumference; however in other embodiments, the distance between recesses may differ. The recesses allow a precise and easy assembly of the rotor pole components 1702 with the annular rotor core back components 1766. Each recess defines a plane contact surface to which a corresponding contact surface of a protrusion 1733 can abut. The contact surface of the recess is delimited by side walls that define the circumferential position of a rotor pole component. It will be appreciated that the annular rotor core back components may comprise different indexing features in addition or alternative to the recesses 1828.

In some embodiments of the rotor, the indexing elements define a generally axially-outward oriented mounting surface abutting a corresponding contact surface of one of the rotor pole elements. The mounting surface may face a direction parallel to the axial direction or a direction that slightly deviates from the axial direction, so as to provide a skewing of the rotor pole elements as described above in connection with the stator. The discs provide higher flux and they allow a higher degree of freedom in providing indexing features etc. in the discs 1766. However, it will be appreciated that a rotor may also be constructed without discs 1766. In such an embodiment, the mounting parts of the rotor pole components may be coupled directly to the permanent magnet.

This kind of rotor could be used in a common radial flux 3-phase stator, and it allows for a large number of poles by using only one magnet, thus resulting in cost savings.

Although some embodiments have been described and shown in detail, the invention is not restricted to them, but may also be embodied in other ways within the scope of the subject matter defined in the following claims. In particular, it is to be understood that other embodiments may be utilised, and that structural and functional modifications may be made without departing from the scope of the present invention. Furthermore, while some features have been explained with reference to certain types of machines, the skilled person will readily appreciate that these features may also be implemented in other types of machines. For example, features illustrated with reference to an inner-rotor machine may also be implemented in an outer-rotor machine. Similarly, embodiments of the stator disclosed herein have mainly been described with reference to claw-pole type machines where the stator pole components have axially extending claws that extend across a part of or the entire axial extent of the air gap. It will be appreciated, however, that alternative embodiments of the stator disclosed herein may be used in machine designs without claws. In such embodiments, an axial flux concentration may at least partly be performed in the rotor, e.g. by means of a rotor design as shown in FIG. 15b, 15c or as described in connection with FIG. 15d. Such embodiments may be particularly beneficial for large machines, as the stator design described herein allows for a robust stator design, even when cost-efficient production methods are used. For example, the annular stator core back component may be manufactured from a plurality of ring segments, and the other stator components may be easily scaled to fit with larger stator designs.

Embodiments of the invention disclosed herein may be used for a direct wheel drive motor for an electric-bicycle or other electrically driven vehicle, in particular a light-weight vehicle. Such applications may impose demands on high torque, relatively low speed and low cost. These demands may be fulfilled by a motor with a relatively high pole number in a compact geometry using a small volume of permanent magnets and wire coils to fit and to meet cost demands by the enhanced rotor assembly routine.

In device claims enumerating several means, several of these means can be embodied by one and the same structural component. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A stator for an electric machine, the stator comprising a stator core and a winding, the stator core comprising:
an annular stator core back component providing a magnetic flux path in at least a circumferential direction and in an axial direction of the annular stator core back component; and
a plurality of stator pole components each comprising a mounting part mounted to the annular stator core back component, an interface part defining an interface surface facing an active air gap between the stator and a rotor of the electrical machine; and
a radially oriented tooth part extending radially from the annular stator core back component and connecting the interface part with the mounting part;
wherein the mounting part of each stator pole component comprises an axially extending protrusion.

2. A stator according to claim 1, wherein the annular stator core back component defines a first axially-outward oriented side face and a second axially-outward oriented side face opposite the first axially-outward oriented side face; and wherein a first subset of the plurality of stator pole components are mounted to the first axially-outward oriented side face, and a second subset of the plurality of stator pole components are mounted to the second axially-outward oriented side face.

3. A stator according to claim 2, wherein the stator pole components are distributed along the circumference of the annular stator core back component, and wherein the stator pole components of the first and second subsets are arranged in an alternating sequence along the circumference.

4. A stator core back according to claim 2, wherein the annular stator core back component provides a magnetic flux path connecting respective stator pole components of the first and second subsets.

5. A stator according to claim 2, wherein the stator comprises a winding sandwiched between the first and second subsets of stator pole components.

6. A stator according to claim 1, wherein the annular stator core back component comprises a plurality of indexing means configured to engage with the mounting part of respective ones of the stator pole components.

7. A stator according to claim 6, wherein each indexing means defines a generally axially-outward oriented mounting surface abutting a corresponding contact surface of one of the stator pole elements; and an indexing element preventing displacement of the stator pole element in a circumferential direction.

8. A stator according to claim 7 wherein the mounting surface faces a direction that deviates from the axial direction.

9. A stator according to claim 1, wherein each stator pole component comprises laminated metal sheets stacked in the circumferential direction.

10. A stator according to claim 1, wherein the interface part of each stator pole component comprises an axially extending claw part.

11. A stator according to claim 1, wherein the axially extending protrusion abuts a radially-oriented rear surface of the annular stator core back component, wherein the rear surface faces away from the interface surface.

12. A stator according to claim 1, further comprising two end plates, wherein the annular stator core back component and the stator pole components are axially sandwiched between the end plates.

13. A stator according to claim 12, wherein at least one of the end plates comprises indexing features mating with respective ones of the stator pole components.

14. An electric machine comprising a stator according to claim 1, and a rotor, the rotor being configured to generate a rotor magnetic field for interaction with a stator magnetic field of the stator, wherein said rotor is adapted to rotate around a longitudinal axis of the rotor.

15. An electric machine according to claim 14, wherein the rotor comprises:
a mounting part defining a cylindrical mounting surface facing the stator; and
a plurality of surface mounted permanent magnets mounted to the mounting surface and arranged circumferentially around the longitudinal axis, each permanent magnet being magnetised in a direction of magnetisation so as to generate a magnetic flux.

16. An electric machine according to claim 14, wherein the rotor comprises:
a plurality of permanent magnets arranged circumferentially around the longitudinal axis, each permanent magnet being magnetised in a direction of magnetisation so as to generate a magnetic flux;
a support structure comprising an inner tubular support member arranged radially inward of the plurality of permanent magnets; and
at least one flux guiding member adapted to provide a path in at least a radial direction for the magnetic flux generated by one or more of the plurality of permanent magnets.

17. An electric machine according to claim 14, wherein the rotor comprises:
an annular permanent magnet magnetised in the axial direction;
a plurality of rotor pole components each comprising a mounting part, an interface part defining an interface surface facing an active air gap between the stator and the rotor; and
a radially oriented tooth part extending radially from the permanent magnet and connecting the interface part with the mounting part.

18. An annular stator core back component for a stator for an electric machine, the annular stator core back component providing a magnetic flux path in a circumferential direction and an axial direction of the annular stator core back component; wherein the annular stator core back component comprises a plurality of indexing means configured to engage with respective ones of a plurality of stator pole components.

19. An annular stator core back component according to claim 18, wherein the annular stator core back component is made from soft magnetic powder.

20. A method of manufacturing a stator as defined in claim 1, the method comprising:
providing a mounting surface;
placing a first subset of the stator pole components on predetermined positions of the mounting surface;
positioning the winding and the annular stator core back component relative to the first subset of stator pole components so as to cause the mounting parts of the stator pole components of the first subset to engage with the annular stator core back component;
positioning the second subset of the stator pole components relative to the annular stator core back component and the first subset of stator pole components so as to cause the mounting parts of the stator pole components of the second subset to engage with the annular stator core back component.

21. A rotor for an electric machine, the rotor being configured to generate a rotor magnetic field for interaction with a stator magnetic field of a stator, wherein said rotor is adapted to rotate around a longitudinal axis of the rotor, wherein the rotor comprises:
an annular permanent magnet magnetised in the axial direction;
a plurality of rotor pole components each comprising a mounting part, an interface part defining an interface surface facing an active air gap between the stator and the rotor; and
a radially oriented tooth part extending radially relative to the permanent magnet and connecting the interface part with the mounting part.

22. A rotor according to claim 21, comprising first and second annular rotor core back components, wherein the annular permanent magnet is sandwiched between the first and second annular rotor core back components, and wherein the mounting part of each rotor pole component is coupled to a respective one of the first and second annular rotor core back components.

23. A rotor according to claim 21, wherein each of the first and second annular rotor core back components comprises a plurality of indexing means configured to engage with the mounting part of respective ones of the rotor pole components.

24. A stator according to claim 1, wherein the axially extending protrusion abuts a depression in an axially-oriented side surface of the annular stator core back component, wherein the axially extending protrusion is spaced from a radially-oriented rear surface of the annular stator core back component, wherein the rear surface faces away from the interface surface.
